(19) United States
(12) Patent Application Publication
(10) Pub. No.: US 2026/0211693 A1
(43) Pub. Date: Jul. 23, 2026

(54) INDICATING SHUTDOWN PROGRESS USING EARLY SIGN OF LIFE TEXT OUTPUT

(71) Applicant: DELL PRODUCTS L.P., Round Rock, TX (US)

(72) Inventors: Yung-Sheng Lin, Bade Dist. (TW); Shun-Tang Hsu, Taipei (TW)

(21) Appl. No.: 19/035,728

(22) Filed: Jan. 23, 2025

(51) Int. Cl. G06F 9/4401; G06F 11/32

(52) U.S. Cl. CPC G06F 9/442; G06F 11/324

(57) ABSTRACT

An information handling system includes an early sign of life (ESOL) controller and a baseboard management controller (BMC). The ESOL controller directs a display device to display first content during a pre-boot phase of operation of the information handling system, prior to the enabling of a video controller of the information handling system. The BMC receives an indication that the information handling system is entering a power down state, and provides first information to the ESOL controller based upon the indication. The ESOL controller further directs the display device to display second content in response to receiving the first information.

### FIELD OF THE DISCLOSURE

This disclosure relates to information handling systems, and more particularly relates to indicating system shutdown progress using early sigh of life (eSOL) text output in an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An information handling system may include an early sign of life (ESOL) controller and a baseboard management controller (BMC). The ESOL controller may direct a display device to display first content during a pre-boot phase of operation of the information handling system, prior to the enabling of a video controller of the information handling system. The BMC may receive an indication that the information handling system is entering a power down state, and provide first information to the ESOL controller based upon the indication. The ESOL controller may further direct the display device to display second content in response to receiving the first information.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1A illustrates an information handling system in a pre-boot phase of operation according to an embodiment of the present disclosure;

FIG. 1B illustrates the information handling system of FIG. 1A in an operating system (OS) run time phase of operation according to an embodiment of the present disclosure;

FIG. 1C illustrates the information handling system of FIG. 1A in an OS shut down phase of operation according to an embodiment of the present disclosure;

FIG. 2 illustrates the information handling system of FIG. 1 and a method for indicating system shutdown progress using early sign of life (ESOL) text output in the information handling system according to an embodiment of the present disclosure; and

FIG. 3 is a block diagram illustrating a generalized information handling system according to another embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

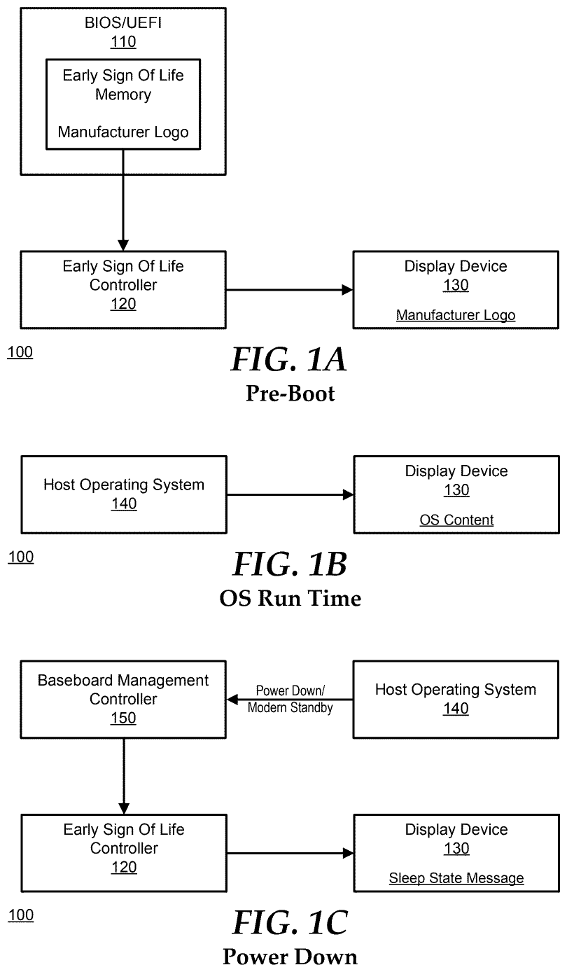

FIGS. 1A-C illustrate an information handling system 100 including a basic input/output system (BIOS)/universal extensible firmware interface (UEFI) 110, an early sign of life (ESOL) controller 120, a display device 130, a host operating system (OS) 140, and a baseboard management controller (BMC) 150. FIG. 1A illustrates a pre-boot phase of operation of information handling system 100. During the pre-boot phase, in order to provide the user of information handling system 100 an indication that the boot is proceeding and is not halted, ESOL controller 120 retrieves an image from an ESOL memory storage of BIOS/UEFI 110 to display on display device 120. In particular, the ESOL memory storage may store a manufacturer logo for display on display device 130 during the early phases of the pre-boot phase. The details of the pre-boot phase of operation of an information handling system, and the display by an ESOL controller of an image during the pre-boot phase of operation are known in the art and will not be further described herein, except as may be needed to illustrate the current embodiments.

FIG. 1B illustrates an OS run time phase of operation of information handling system 100. During the run time phase, host OS 140 operates to drive the content displayed on display device 130. For example, host OS 140 can drive windows-type display content, command line display content, or another type of display content, as needed or desired. The run time operation of an OS, and the resulting display of OS content on a display device are known in the art, and will not be further described herein, except as may be needed to illustrate the current embodiments.

FIG. 1C illustrate a power down phase of operation of information handling system 100. During the power down phase, host OS 140 initiates a power down operation. Such a power down operation may be initiated by a user input to information handling system 100, by a OS-or BIOS-initiated action, by a management system action, such as a command from BMC 150, or by another type of action to shut down the information handling system, as needed or desired. The power down operation may include a change to a system power state, such as a change from a power-on state to a sleep state, a power-off state, a standby state, a modern standby state, or the like.

During the transition from the OS run time phase of operation to a power down phase of operation on the typical information handling system, the OS-based display driver will halt, leaving a blank display on the display device for a duration of time while further background processes are halted. It has been understood by the inventors of the current disclosure that the blank display on the display device may be unsettling to a user of the information handling system. For example, the user may be unsure as to whether the blank display is the result of the power to the display being turned off, if the action of shutting down the information handling system resulted in a failure which halted the power down process (that is, the information handling system experience a processing hang), or if the action of shutting down the information handling system is proceeding normally. That is, in all the above cases, the indication is the same (that is, a blank display).

In a particular embodiment, host OS 140 provides an indication of the power down request to BMC 150. BMC 150 may be powered on a different power plane of information handling system 100 that permits the BMC to continue processing activities after the processing activities of a host processor has been halted and the host processor has been powered down. Thus, BMC 150 may operate in separately from host OS 140. Thus, BMC 140 operates to receive the indication of the power down request and to forward information to ESOL controller 120 that the ESOL controller provides to display device 130 while the power down phase of operation is proceeding. In a particular embodiment, BMC 150 sends different information to ESOL controller 120 based upon the nature of the power down request. For example, if the user of information handling system 100 initiated the power down request, the information provided to display device 130 may be a more user-friendly message. On the other hand, if the power down request was initiated by OS 140, such as for a software update, or by BIOS/UEFI 110, such as for a firmware update, the information provided to display device 130 may be more informative, describing the cause of the power down operation. In another embodiment, BMC 150 sends multiple information to ESOL controller to provide a running status report on display device 130 as to the progress of the power down operation.

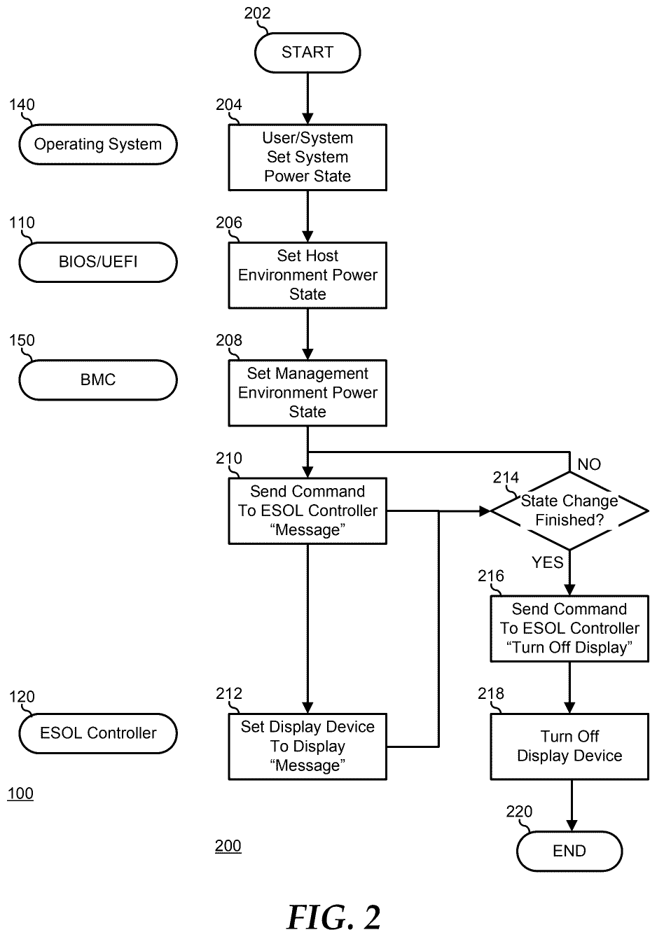

FIG. 2 illustrates information handling system 100 and a method 200 for indicating system shutdown progress using ESOL text output in the information handling system, starting at block 202. In block 204, a user or information handling system 100 operates within OS 140 to set a system power state. For example, a request can be made to set a power down state, a stand by state, a moder stand by state, or the like. BIOS/UEFI 110 receives the power down state request and sets the host environment to the requested power state in block 206. For example, BIOS/UEFI 110 may suspend processing threads on a host processor, may shut down applications on OS 140, may halt various communication interfaces, or the like.

BMC 150 receives the power down state request and sets the management environment to the requested power state in block 208. For example, BMC 150 may shut down a cooling system for information handling system 100, provide an indication of the power down operation to a management system connected to information handling system 100, or the like. BMC 150 determines the nature of the power down operation (such as power state, stand by state, modern stand by state, or the like), and sends a command including message information to ESOL controller 120 in block 210. For example, BMC 150 may send various information based upon the nature of the power down operation. Also, method 200 proceeds to decision block 214, as described further below.

ESOL controller 130 receives the information from BMC 150 and sets display device 130 to display the information specified in the information in block 212 and method 200 proceeds to decision block 214. A decision is made as to whether or not the requested state change is finisheded in decision block 214. If not, the “NO” branch of decision block 214 is taken and the method returns to block 210 where BMC 150 sends the information to ESOL controller 120. Here, BMC 150 may operate to monitor the progress of the power down operation, and to update the information to ESOL controller 120, as needed or desired. If the requested state change is finished, the “YES” branch of decision block 214 is taken and BMC 150 sends a comma d to ESOL controller 120 to turn off display device 130 in block 216. ESOL controller 120 turns off display device 130 in block 218, and the method ends in block 220.

In a particular embodiment, the information sent from BMC 150 to ESOL controller 120 does not include the actual text to be displayed by display device 130. Instead, the information sent from BMC 150 to ESOL controller 120 is encoded with information which is received by the ESOL controller. ESOL controller 120 includes predetermined messages stored in a memory associated with the ESOL controller, and the ESOL controller decodes the information to determine the message to display on display device.

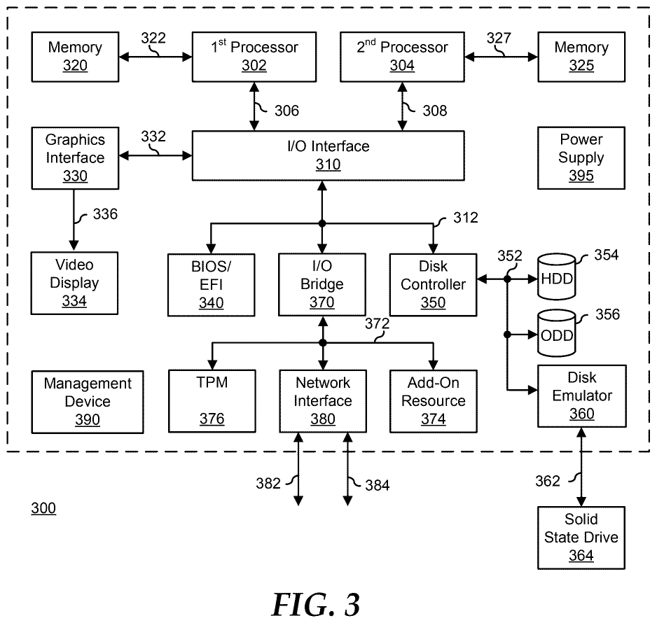

FIG. 3 illustrates a generalized embodiment of an information handling system 300 similar to information handling system 300. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 300 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below, and operates to perform one or more of the methods described below. Information handling system 300 includes a processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356, a disk emulator 360 connected to an external solid state drive (SSD) 362, an I/O bridge 370, one or more add-on resources 374, a trusted platform module (TPM) 376, a network interface 380, a management device 390, and a power supply 395. Processors 302 and 304, I/O interface 310, memory 320, graphics interface 330, BIOS/UEFI module 340, disk controller 350, HDD 354, ODD 356, disk emulator 360, SSD 362, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332, and provides a video display output 336 to a video display 334. In a particular embodiment, information handling system 300 includes separate memories that are dedicated to each of processors 302 and 304 via separate memory interfaces. An example of memories 320 and 330 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 1394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312, or can be a different type of interface. As such, I/O bridge 370 extends the capacity of I/O channel 312 where peripheral interface 372 and the I/O channel are of the same type, and the I/O bridge translates information from a format suitable to the I/O channel to a format suitable to the peripheral channel 372 where they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300. Management device 390 can operate off of a separate power plane from the components of the host environment so that the management device receives power to manage information handling system 300 where the information handling system is otherwise shut down. An example of management device 390 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed:

1. An information handling system, comprising:
an early sign of life (ESOL) controller configured to direct a display device to display first content during a pre-boot phase of operation of the information handling system, prior to the enabling of a video controller of the information handling system; and
a baseboard management controller (BMC) configured to receive an indication that the information handling system is entering a power down state, and to provide first information to the ESOL controller based upon the indication;
wherein the ESOL controller is further configured to direct the display device to display second content in response to receiving the first information.

2. The information handling system of claim 1, wherein the first information includes a message to display on the display device.

3. The information handling system of claim 2, wherein the second content includes the message.

4. The information handling system of claim 1, wherein the ESOL controller includes a plurality of messages.

5. The information handling system of claim 4, wherein the first information includes a code.

6. The information handling system of claim 5, wherein the ESOL controller is further configured to select a particular one of the messages based upon the code.

7. The information handling system of claim 6, wherein the second content includes the particular message.

8. The information handling system of claim 1, wherein the BMC is further configured to monitor progress of a power down operation of the information handling system in response to receiving the indication, and, subsequent to providing the first information, to provide second information to the ESOL controller.

9. The information handling system of claim 8, wherein the ESOL controller is further configured to direct the display device to display third content in response to receiving the second information.

10. The information handling system of claim 1, wherein the BMC is further configured to power down a management environment of the information handling system in response to receiving the indication.

11. A method, comprising:
providing, on an information handling system, an early sign of life (ESOL) controller configured to direct a display device to display first content during a pre-boot phase of operation of the information handling system, prior to the enabling of a video controller of the information handling system;
receiving, by a baseboard management controller (BMC) of the information handing system, an indication that the information handling system is entering a power down state;
providing, by the BMC, first information to the ESOL controller based upon the indication; and
directing, by the ESOL controller, the display device to display second content in response to receiving the first information.

12. The method of claim 11, wherein the first information includes a message to display on the display device.

13. The method of claim 12, wherein the second content includes the message.

14. The method of claim 11, wherein the ESOL controller includes a plurality of messages.

15. The method of claim 14, wherein the first information includes a code.

16. The method of claim 5, further comprising selecting, by the ESOL controller, a particular one of the messages based upon the code.

17. The method of claim 6, wherein the second content includes the particular message.

18. The method of claim 11, further comprising:
monitoring, by the BMC, progress of a power down operation of the information handling system in response to receiving the indication; and
subsequent to providing the first information, providing, by the BMC, second information to the ESOL controller.

19. The method of claim 18, further comprising directing, by the ESOL controller, the display device to display third content in response to receiving the second information.

20. An information handling system, comprising:
an early sign of life (ESOL) controller configured to direct a display device to display first content during a pre-boot phase of operation of the information handling system, prior to the enabling of a video controller of the information handling system;
an operating system instantiated on the information handling system, the operating system configured to enter the information handling system into a power down state; and
a baseboard management controller configured to receive an indication from the operating system that the information handling system is entering the power down state, and to provide information to the ESOL controller based upon the indication;
wherein the ESOL controller is further configured to direct the display device to display second content in response to receiving the information.
